(19) United States
(12) Patent Application Publication
(10) Pub. No.: US 2026/0054923 A1
(43) Pub. Date: Feb. 26, 2026

(54) FULL-GEAR FOUR-WAY SHUTTLE AND A WORKING METHOD THEREOF

(71) Applicant: Bullseye Intelligent Logistics Equipment (Suzhou) Co., Ltd., Suzhou (CN)

(72) Inventors: Jian Shen, Suzhou (CN); Libin Kuai, Suzhou (CN); Youcai Shen, Suzhou (CN); Xiangming Wang, Suzhou (CN); Linhua Chen, Suzhou (CN)

(21) Appl. No.: 19/174,680

(22) Filed: Apr. 9, 2025

(30) Foreign Application Priority Data
Aug. 22, 2024 (CN) 202411156389.9

(51) Int. Cl. B65G 1/04; B61C 9/48

(52) U.S. Cl. CPC B65G 1/0492; B61C 9/48

(57) ABSTRACT

A full-gear four-way shuttle, including a two-direction travel servo motor planetary reducer, a jacking reversing servo motor planetary reducer, a jacking reversing gearbox, a jacking reversing drive shaft, a Y-direction travel gearbox and an X-direction travel gearbox. The disclosure also includes a method to operate the full-gear four-way shuttle, in which a jacking reversing servo motor planetary reducer drives a jacking reversing drive shaft to rotate through a jacking reversing gearbox and to move with a cam swing arm; the cam swing arm moves synchronously and drives the full-gear four-way shuttle to move in a reverse direction.

### FIELD OF THE INVENTION

The present invention relates generally to warehousing logistics equipment, and more specifically, to a full-gear four-way shuttle and its working method.

### DESCRIPTION OF THE RELATED ART

In modern warehousing and logistics operations, an increasing number of factories utilize integrated automation systems that combine shuttles and shelving systems to replace traditional warehousing methods. Among these, the four-way shuttle stands out due to its higher cost efficiency.

However, the inventors of the present disclosure have recognized several limitations in existing four-way shuttles. Traditionally, multi-wheel drive systems are employed for shuttle travel, with most conventional systems relying on chain transmission for power delivery. This approach often results in difficulty maintaining synchronized movement. Additionally, the inventors have observed asynchronous hydraulic lifting, which requires frequent maintenance to ensure the shuttle's stable operation. These challenges place a significant burden on operators and inadvertently increase labor costs.

### BRIEF SUMMARY OF THE INVENTION

In light of the aforementioned disadvantages of existing technologies, the present invention provides a full-gear four-way shuttle and its working method.

The full-gear four-way shuttle generally comprises a two-direction travel servo motor planetary reducer, a lifting and reversing servo motor planetary reducer fixedly connected to the two-direction travel servo motor planetary reducer, a lifting and reversing gearbox installed to the lifting and reversing servo motor planetary reducer, a lifting and reversing drive shaft connected to the lifting and reversing gearbox, a Y-direction travel gearbox fixedly connected to the lifting and reversing gearbox, and an X-direction travel gearbox fixedly connected to the Y-direction travel gearbox.

Preferably, a universal telescopic coupling is installed to the two-direction travel servo motor planetary reducer, a cam swing arm is installed to the lifting and reversing drive shaft, an X-direction travel wheel is installed to the Y-direction travel gearbox, and a Y-direction travel wheel is installed to the X-direction travel gearbox.

Preferably, a Y-direction travel drive shaft is installed to the universal telescopic coupling, a battery is fixedly connected to the lifting and reversing servo motor planetary reducer, and an X-direction guide slider is fixedly connected to the Y-direction travel gearbox.

Preferably, a groove-shaped positioning photoelectric group and a positioning device are installed to the X-direction travel gearbox.

Preferably, the full-gear four-way shuttle includes two X-direction travel gearboxes and two Y-direction travel gearboxes; four travel gearboxes form a square-shaped structure.

Preferably, the universal telescopic coupling is installed to the Y-direction travel gearbox through a rotating shaft; the cam swing arm is slidingly connected to the X-direction guiding slider.

Preferably, the full-gear four-way shuttle includes more than one X-direction travel wheel, each Y-direction travel gearbox is installed with two X-direction travel wheels.

Preferably, the full-gear four-way shuttle includes more than one Y-direction travel wheel, each X-direction travel gearbox is installed with four Y-direction travel wheels.

Preferably, the battery is electrically connected to the two-direction travel servo motor planetary reducer through a wire, and the battery is further electrically connected to the lifting and reversing servo motor planetary reducer through a wire.

The invention further provides a method to operate the full-gear four-way shuttle, comprising three steps:
S1: a two-direction travel servo motor planetary reducer is started, which, through a universal telescopic coupling, controls an X-direction travel gearbox; the X-direction travel gearbox drives X-direction travel wheels to rotate, enabling them to roll along an X-direction track for movement;
S2: a lifting and reversing servo motor planetary reducer is started, which, through a lifting and reversing gearbox, drives a lifting and reversing drive shaft to rotate; this movement drives a cam swing arm to move along an X-direction guide slider in an upward direction; the cam swing arm moves synchronously in the upward direction; enabling directional switching;
S3: the two-direction travel servo motor planetary reducer, through the universal telescopic coupling, controls a Y-direction travel gearbox; the Y-direction travel gearbox then drives a Y-direction travel drive shaft to rotate, which in turn drives Y-direction travel wheels to roll along a Y-direction track.

In this respect, before explaining at least one embodiment of the invention in detail, it is to be understood that the invention is not limited in its application to the details of construction and to the arrangements of the components set forth in the following description or illustrated in drawings. The invention is capable of other embodiments and of being practiced and carried out in various ways. Also, it is to be understood that the phraseology and terminology employed herein are for the purpose of the description and should not be regarded as limiting.

Compared to prior disclosures, the present disclosure offers the following advantages. First, the lifting and reversing servo motor planetary reducer drives the lifting and reversing drive shaft through the lifting and reversing gearbox, ensuring that the upward telescopic movement of the cam swing arm remains synchronized. This eliminates asynchronous lifting issues. Unlike conventional systems, this mechanism does not rely on electronic control or software programs, thereby preventing issues caused by network communication failures, software vulnerabilities, or hydraulic lifting malfunctions, ultimately reducing the risk of economic losses and safety hazards. Second, in high-density storage environments, where shelves or floors are relatively tall and entry/exit points are typically at ground level, a four-way shuttle is required to transport goods between different levels via layer-changing elevators. The shuttle must navigate between upper-level shelves or floors to facilitate warehouse entry and exit operations. This design ensures that the cam swing arm moves upward synchronously while simultaneously driving the four-way shuttle in reverse, enhancing the shuttle's stability and operational efficiency.

To the accomplishment of the above and related advantages, this disclosure may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the full-gear four-way shuttle.

FIG. 2 is a sectional view of the full-gear four-way shuttle.

FIG. 3 is a side view of the full-gear four-way shuttle.

FIG. 4 is another side view of the full-gear four-way shuttle.

FIG. 5 is another side view of the full-gear four-way shuttle.

### DETAILED DESCRIPTION OF THE INVENTION

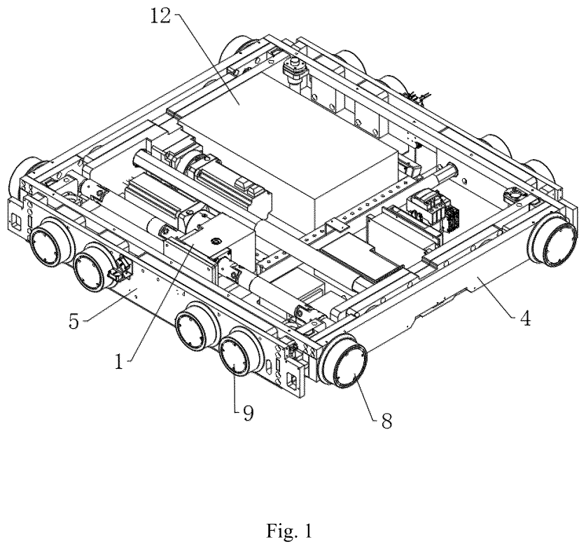

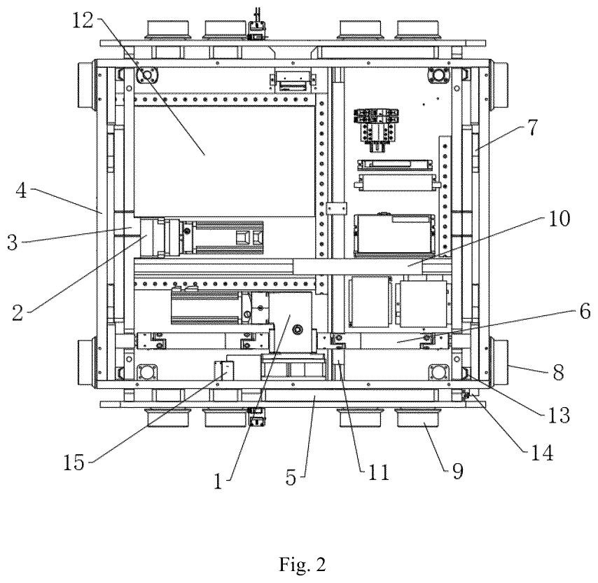

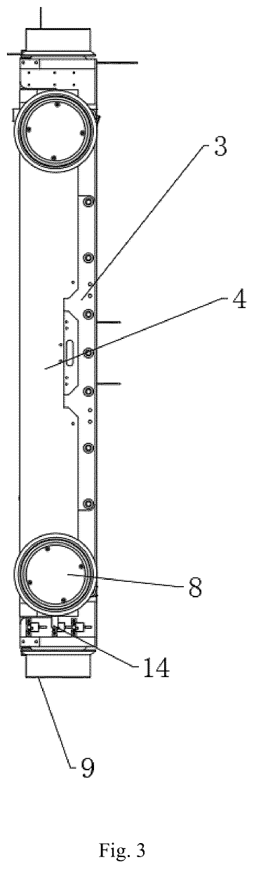

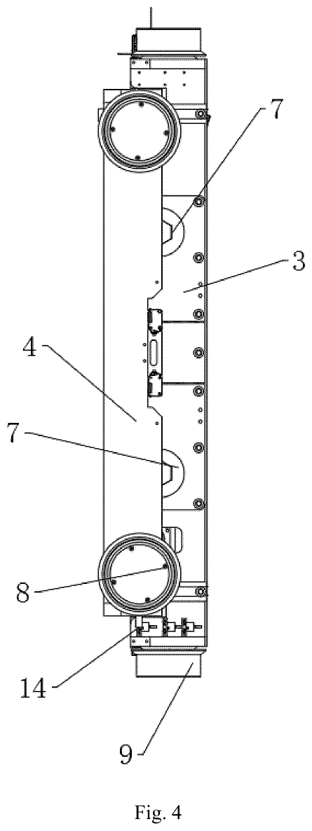

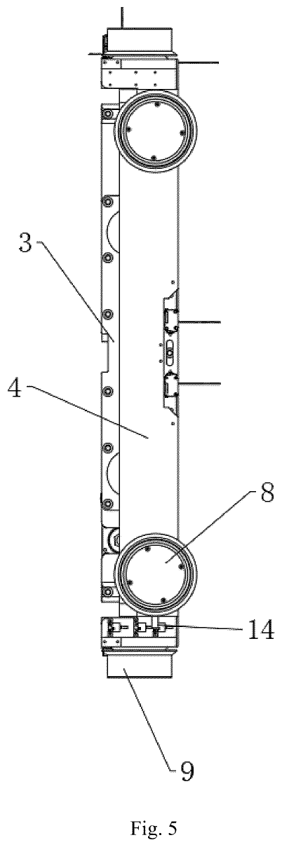

Turning now descriptively to the drawings, in which similar reference characters denote similar elements throughout the several views, FIG. 1 through 5 illustrate a full-gear four-way shuttle, including a two-direction travel servo motor planetary reducer 1, a lifting and reversing servo motor planetary reducer 2 fixedly connected to the two-direction travel servo motor planetary reducer 1, a lifting and reversing gearbox 3 installed to the lifting and reversing servo motor planetary reducer 2, a lifting and reversing drive shaft 10 connected to the lifting and reversing gearbox 3, a Y-direction travel gearbox 4 fixedly connected to the lifting and reversing gearbox 3, and an X-direction travel gearbox 5 fixedly connected to the Y-direction travel gearbox 4.

A universal telescopic coupling 6 is installed to the two-direction travel servo motor planetary reducer 1, a cam swing arm 7 is installed to the lifting and reversing drive shaft 10, an X-direction travel wheel 8 is installed to the Y-direction travel gearbox 4, and a Y-direction travel wheel 9 is installed to the X-direction travel gearbox 5. A Y-direction travel drive shaft 11 is installed to the universal telescopic coupling 6, a battery 12 is fixedly connected to the lifting and reversing servo motor planetary reducer 2, and an X-direction guiding slider 13 is fixedly connected to the Y-direction travel gearbox 4. A groove-shaped positioning photoelectric group 14 and a positioning device 15 are installed to the X-direction travel gearbox 5.

When the full-gear four-way shuttle is working, the X-direction travel wheel 8 is placed on an X-direction track, and then the two-direction travel servo motor planetary reducer 1 is started to control the X-direction travel gearbox 5 through the universal telescopic coupling 6, and the X-direction travel gearbox 5 drives the X-direction travel wheel 8 to rotate, so that the X-direction travel wheel 8 rolls on the X-direction track.

The full-gear four-way shuttle comprises two X-direction travel gearboxes 5 and two Y-direction travel gearboxes 4; four travel gearboxes form a square-shaped structure. The universal telescopic coupling 6 is installed to the Y-direction travel gearbox 4 through a rotating shaft; the cam swing arm 7 is slidingly connected to the X-direction guiding slider 13. The full-gear four-way shuttle includes more than one X-direction travel wheel 8, each Y-direction travel gearbox 4 is installed with two X-direction travel wheels 8; it also includes more than one Y-direction travel wheel 9, each X-direction travel gearbox 5 is installed with four Y-direction travel wheels 9. The battery 12 is electrically connected to the two-direction travel servo motor planetary reducer 1 through a wire, and the battery 12 is further electrically connected to the lifting and reversing servo motor planetary reducer 2 through a wire.

The lifting and reversing servo motor planetary reducer 2 is started and drives the lifting and reversing drive shaft 10 to rotate through the lifting and reversing gearbox 3, so that the lifting and reversing drive shaft 10 moves along with the cam swing arm 7, so that the cam swing arm 7 slides upward along the X-direction guide block 13, thus driving the cam swing arm 7 move upward. Then the cam swing arm 7 moves up synchronously, and the cam swing arm 7 drives the four-way shuttle to reverse direction, and then the two-direction travel servo motor planetary reducer 1 controls the Y-direction travel gearbox 4 through the universal telescopic coupling 6, so that the Y-direction travel gearbox 4 drives the Y-direction travel wheel 9 through the Y-direction travel drive shaft 11. Then the Y-direction travel wheel 9 rolls on the Y-direction track.

The invention also discloses a method to operate the full-gear four-way shuttle, comprising three steps:
S1: a two-direction travel servo motor planetary reducer 1 is started, which, through a universal telescopic coupling 6, controls an X-direction travel gearbox 5; the X-direction travel gearbox 5 drives X-direction travel wheels 8 to rotate, enabling them to roll along an X-direction track for movement;
S2: a lifting and reversing servo motor planetary reducer 2 is started, which, through a lifting and reversing gearbox 3, drives a lifting and reversing drive shaft 10 to rotate; this movement drives a cam swing arm 7 to move along an X-direction guide slider 13 in an upward direction; the cam swing arm 7 moves synchronously in the upward direction; enabling directional switching;
S3: the two-direction travel servo motor planetary reducer 1, through the universal telescopic coupling 6, controls a Y-direction travel gearbox 4; the Y-direction travel gearbox 4 then drives a Y-direction travel drive shaft 11 to rotate, which in turn drives Y-direction travel wheels 9 to roll along a Y-direction track.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A full-gear four-way shuttle, comprising a two-direction travel servo motor planetary reducer, a lifting and reversing servo motor planetary reducer fixedly connected to the two-direction travel servo motor planetary reducer, a lifting and reversing gearbox installed to the lifting and reversing servo motor planetary reducer, a lifting and reversing drive shaft connected to the lifting and reversing gearbox, a Y-direction travel gearbox fixedly connected to the lifting and reversing gearbox, and an X-direction travel gearbox fixedly connected to the Y-direction travel gearbox.

2. The full-gear four-way shuttle in claim 1, wherein a universal telescopic coupling is installed to the two-direction travel servo motor planetary reducer, a cam swing arm is installed to the lifting and reversing drive shaft, an X-direction travel wheel is installed to the Y-direction travel gearbox, and a Y-direction travel wheel is installed to the X-direction travel gearbox.

3. The full-gear four-way shuttle in claim 2, wherein a Y-direction travel drive shaft is installed to the universal telescopic coupling, a battery is fixedly connected to the lifting and reversing servo motor planetary reducer, and an X-direction guide slider is fixedly connected to the Y-direction travel gearbox.

4. The full-gear four-way shuttle in claim 3, wherein a groove-shaped positioning photoelectric module and a positioning device are installed to the X-direction travel gearbox.

5. The full-gear four-way shuttle in claim 4, including two X-direction travel gearboxes and two Y-direction travel gearboxes; four travel gearboxes form a square-shaped structure.

6. The full-gear four-way shuttle in claim 4, wherein the universal telescopic coupling is installed on the Y-direction travel gearbox through a rotating shaft; the cam swing arm and the X-direction guide slider form a slidingly connection.

7. The full-gear four-way shuttle in claim 4, wherein multiple X-direction travel wheels are installed, with each Y-direction travel gearbox connected to two X-direction travel wheels.

8. The full-gear four-way shuttle in claim 4, wherein multiple Y-direction travel wheels are installed, with each X-direction travel gearbox connected to four Y-direction travel wheels.

9. The full-gear four-way shuttle in claim 4, wherein the battery is electrically connected to the two-direction travel servo motor planetary reducer and the lifting and reversing servo motor planetary reducer via wiring.

10. A method to operate a full-gear four-way shuttle, comprising following steps:
S1: a two-direction travel servo motor planetary reducer is started, which, through a universal telescopic coupling, controls an X-direction travel gearbox; the X-direction travel gearbox drives X-direction travel wheels to rotate, enabling them to roll along an X-direction track for movement;
S2: a lifting and reversing servo motor planetary reducer is started, which, through a lifting and reversing gearbox, drives a lifting and reversing drive shaft to rotate; this movement drives a cam swing arm to move along an X-direction guide slider in an upward direction; the cam swing arm moves synchronously in the upward direction; enabling directional switching;
S3: the two-direction travel servo motor planetary reducer, through the universal telescopic coupling, controls a Y-direction travel gearbox; the Y-direction travel gearbox then drives a Y-direction travel drive shaft to rotate, which in turn drives Y-direction travel wheels to roll along a Y-direction track.
